(19) United States
(12) Patent Application Publication
(10) Pub. No.: US 2022/0118709 A1
(43) Pub. Date: Apr. 21, 2022

(54) DISTRIBUTING PRINT AGENTS IN ADDITIVE MANUFACTURING

(71) Applicant: Hewlett-Packard Development Company, L.P., Spring, TX (US)

(72) Inventors: Matthew A. Shepherd, Vancouver, WA (US); Morgan T. Schramm, Vancouver, WA (US); Vanessa Verzwyvelt, Vancouver, CA (US); Dennis J Schissler, San Diego, CA (US); Xin Cheng, Vancouver, WA (US); Jacob Wright, San Diego, CA (US)

(73) Assignee: Hewlett-Packard Development Company, L.P., Spring, TX (US)

(21) Appl. No.: 17/418,790

(22) PCT Filed: Jul. 8, 2019
(86) PCT No.: PCT/US2019/040862

§ 371 Date: Jun. 26, 2021

(51) Int. Cl. B29C 64/393; B29C 64/165; B29C 64/343; B33Y 50/02

(52) U.S. Cl. CPC B29C 64/393; B29C 64/165; B29K 2105/0032; B33Y 50/02; B29C 64/343

(57) ABSTRACT

In an example, a method includes segmenting, using a processor, a virtual volume comprising a representation of at least a part of an object to be generated in additive manufacturing. The virtual volume may be segmented into a plurality of segments and the object may be intended to have a first color. Additive manufacturing control instructions may be determined for the segments. The additive manufacturing control instructions may comprise instructions for distributing the print agent composition and the additive manufacturing control instructions for each segment may be determined based on the thermal properties of a print agent composition intended to provide the first color to compensate for variations in object dimensions associated with the thermal properties.

### BACKGROUND

Three-dimensional (3D) printing is an additive manufacturing process in which three-dimensional objects may be formed, for example, by the selective solidification of successive layers of a build material. The object to be formed may be described in a data model. Selective solidification may be achieved, for example, by fusing, binding, or solidification through processes including sintering, extrusion, and irradiation. The quality, appearance, strength, and functionality of objects produced by such systems can vary depending on the type of additive manufacturing technology used.

### BRIEF DESCRIPTION OF DRAWINGS

Non-limiting examples will now be described with reference to the accompanying drawings, in which:

FIG. 1 shows an example method for determining additive manufacturing control instructions;

FIG. 2 shows an example of a segmented model;

FIG. 3 is another example method of determining additive manufacturing control instructions;

FIG. 4 shows another example of a segmented model;

FIGS. 5 and 6 are examples of apparatus for processing data relating to additive manufacturing; and

FIG. 7 is an example of a machine readable medium in association with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be determined (which may for example be determined from structural design data). The fusing agent may have a composition which absorbs energy such that, when energy (for example, heat) is applied to the layer, the build material coalesces and solidifies to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60Q “HP fusing agent” available from HP Inc. In examples such a fusing agent may comprise any or any combination of an infra-red light absorber, a near infra-red light absorber, a visible light absorber, and a UV light absorber.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, a coalescence modifier agent may have a cooling effect, and thus be termed a ‘cooling agent’, or may be termed a fusion inhibiting agent. While a cooling action may assist in reducing coalescence by reducing the temperature of the build material to prevent it from reaching its melting point, in some examples, other processes, such as increasing a separation between build material particles may also contribute to decreasing coalescence. In some examples, detailing agent may be used in particular near edge surfaces of an object being printed, although it may also be used in other regions, and may for example be distributed according to a distribution map or pattern, which may be derived from data representing a slice of a three-dimensional object to be generated. According to one example, a suitable detailing agent may be a formulation commercially referred to as V1Q61A “HP detailing agent” available from HP Inc. In some examples, the detailing agent is an aqueous composition (comprising a high percentage of water) which undergoes evaporation when heated, resulting in a cooling effect. Other compositions may also inhibit fusing (e.g., alcohol, glycol or the like, for example ethanol, ethylene glycol, glycerin/glycerol, and/or propylene glycol).

A coloring agent, for example comprising a dye or colorant, may in some examples be used as a fusing agent or a coalescence modifier agent, and/or as a print agent to provide a particular color for the object. The colorant may comprise organic pigment, inorganic pigment, organic dye, thermochromic dye such as leuco dye, or the like. The colorant may be selected to (in some examples in combination with a fusing agent) provide a target color within a color space which may be applied to the layer of build material. For example, the colorant may comprise a choice of different colored agents, for example, from a CYMK (cyan, magenta, yellow, and black) color set, in some examples with the addition of orange, green and violet colored agents, and/or light versions of the CYM agents, and the like. In other examples, alternative colorant sets may be provided. Examples of print agents comprising visible light absorption enhancers are dye based colored ink and pigment based colored ink, such as inks commercially referred to as CE039A and CE042A available from HP Inc.

In some examples, while a fusing agent may be black in color, a black colorant of a colorant set such as the CMYK colorant set may comprise a cosmetic black colorant, selected for its color properties, whereas a black colored fusing agent may comprise a material (such as carbon black) selected for its energy absorptance in the near-infrared range. In other words, a cosmetic black colorant may be provided in addition to at least one fusing agent, even where that fusing agent is black in color. The cosmetic black agent may have lower absorptance than the fusing agent in a waveband of radiation intended to result in heating of the build material.

As noted above, additive manufacturing systems may generate objects based on structural design data. This may involve a designer providing a three-dimensional model of at least one object to be generated, for example using a computer aided design (CAD) application. The model may define the solid portions of the object(s), and, in some examples, at least one object color, wherein different colors may be associated with different object portions in some examples. To generate three-dimensional object(s) from the model using an additive manufacturing system, model data can be processed to determine slices, or parallel planes, of the model. Each slice may define a portion of a respective layer of build material that is to be solidified or caused to coalesce by the additive manufacturing system.

When printing 3D color objects, there may be differences in the amount of thermal energy absorbed associated with the print agents used. The amount of thermal energy available for fusing depends in part on the intensity with which the fusing agent absorbs the radiation (its ‘absorptance’), and the absorptance of the fusing agent depends in part on the color of the fusing agent. For example, a carbon black composition may be an effective fusing agent as it has a high energy absorptance in the infrared and near infrared range. Other print agents may be used as fusing agents. For example, the absorptance of suitable cyan, magenta, or yellow (C, M, or Y) colorants for use in additive manufacturing, while generally lower than that of, for example, carbon black-based fusing agent, may be sufficiently high that they may function as fusing agents, in some examples if mixed with a low tint-fusing agent. Low-tint fusing agents which have a relatively high absorptance (for example comprising a Caesium Tungsten Bronze, or a Caesium Tungsten Oxide composition) and which are lighter in color than a carbon black based print agent may be used as fusing agents, for example being mixed with colorants to increase the energy absorptance.

In summary, therefore, certain colors may be associated with print agent compositions, and those print agent compositions may be associated with different amounts of energy absorbance (i.e. the print agent compositions may have different absorptances), which means that the temperatures reached during additive manufacturing may depend on an intended color of a portion of an object to be generated. Differences in generated temperatures can in turn be associated with a departure from intended object dimension(s).

For example, it may be the case that, where an object is generated in a process which includes heat, additional build material may adhere to the object on generation. In one example, fusing agent may be associated with a region of the layer which is intended to fuse. However, when energy is supplied, build material of neighboring regions may become heated and fuse to the outside of the object (in some examples, being fully or partially melted, or adhering to melted build material as powder). Therefore, a dimension of a generated object may be larger than the regions to which fusing agent is applied. In other examples, objects may be smaller following object generation than is specified in object model data. For example, some build materials used to generate objects may shrink on cooling. In another example, build material may not fuse up to the boundary to which fusing agent is applied as such edge regions may be cooler than inner regions, and therefore the melting temperature may not be reached in the edge regions.

As described in greater detail below, such effects may be compensated for by considering the extent of a region to which print agents may be applied. A particular object may be subject to mechanisms which result in growth and/or smaller than anticipated dimensions, and the appropriate compensation may be influenced by the different degrees to which an object may be affected by such processes.

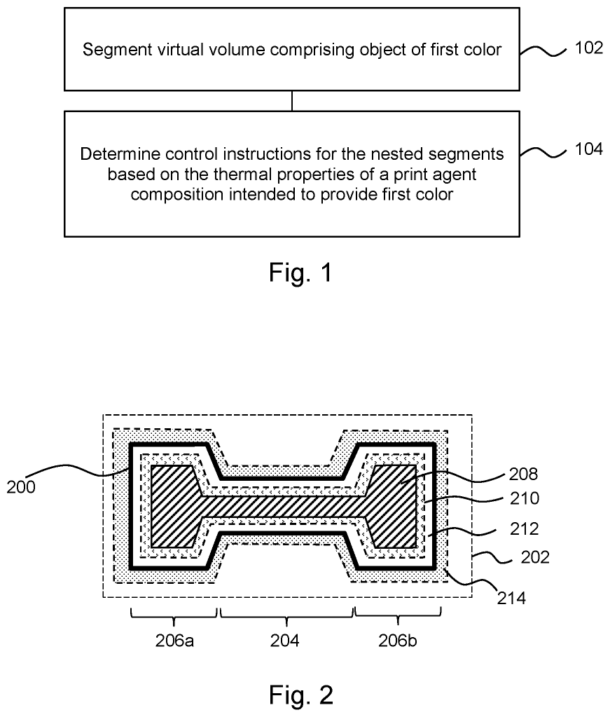

FIG. 1 is an example of a method, which may be a computer implemented method of determining additive manufacturing control instructions, and which may be carried out using one or more processors.

Block 102 comprises using at least one processor to segment a virtual volume comprising a representation of at least a part of an object to be generated in additive manufacturing. The virtual volume is segmented into a plurality of segments and the object is intended to have a first color (for example, in at least a portion thereof, as the object may, in some examples, as well as at least one other color). The virtual volume may for example comprise a boundary box enclosing the object, may be the size and shape of the object (i.e. follow the surfaces of the object), and/or represent at least part of a build volume of a fabrication chamber in which the object is to be fabricated (in some examples along with other objects, which may also be associated with segments, which may be separately defined for those objects). In some examples, the virtual volume may comprise one or more ‘slices’, each of which may represent a layer of the object to be fabricated in layer-by-layer additive manufacturing of the object, and/or a layer of fabrication chamber content which includes the object (in some examples, along with other objects). In some examples, the virtual volume may be ‘voxelized’, that is divided into sub-volumes, which may have the same size and shape as one another. In such an example, segmenting the virtual volume may comprise associating each voxel with a segment.

As described in greater detail herein after, the segments may be nested segments associated with an object, and may be determined so as to have a shape based on the shape of at least part of a surface of the object. In some examples, as described in greater detail below, there may be a plurality of nested peripheral segments associated with an object, which may in some examples be arranged about a core segment. The nesting of the segments may be complete or partial (i.e. a peripheral segment may extend around the entire perimeter of a core segment or an inner peripheral segment, or around just a portion of the perimeter). In some examples, segments may be defined as ‘shells’ which follow the contours of an object surface.

In some examples, the segments may be defined to have a predetermined characteristic, for example a width, and may follow the contour of the object's surface. A relative volumetric composition and a shape for the segments may be determined. The shape may be determined such that at least one segment has a variable thickness. In some examples, a localized relative volumetric composition for the segments within the object may be determined based on a local geometry of the object. For example, in the region of a smaller object feature, a core segment may occupy a relatively larger relative volume than in the region of a larger object feature.

The representation of the object may for example comprise a data model and may for example be received from a memory, over a network, over a communications link or the like. Such a data model may for example comprise object model data and, in some examples, object property data. The object model data may define a three-dimensional geometric model of at least part of the model object, including the shape and extent of all or part of an object in a three-dimensional co-ordinate system. In some examples, the data model may represent the surfaces of the object, for example as a polygon mesh (e.g. as an STL file). In other examples, the data model may describe the object using voxels, i.e. three-dimensional pixels as described above. The object model data may for example be determined by a computer aided design (CAD) application. Object property data may define at least one object property for the, or a part of the, three-dimensional object to be generated. If no object property data is present the object may have some default properties based on the build material and print agents used. In one example, the object property data may comprise any or any combination of a color, flexibility, elasticity, rigidity, surface roughness, porosity, inter-layer strength, density, transparency, conductivity and the like for at least a part of the object to be generated. The object property data may define multiple object properties for part or parts of an object, and the properties specified may vary over the object.

In examples in which the volume is voxelized, the dimensions of a segment may be determined in voxels. For example, a segment may be at least one voxel wide in at least one axis. In one example, a segment may extend for 1 (i.e. a single) voxel in each of the x, y and z axes. However, the extent of the segment may be different for different axes, and/or may be thicker than 1 voxel in at least one axis. In some examples, voxels may be used to characterize print addressable regions, but the voxels used to define segments may not be the same size and/or shape as such voxels. The voxels can be defined arbitrarily small for the purposes of correcting dimensions at an intended resolution, and may be defined to be as large as possible to reduce computational resources while achieving that intended resolution. As is described in greater detail below, in some examples, segments (for example, each being a predetermined width, such as one voxel wide) may be grouped, for example based on object geometry.

Block 104 comprises, using at least one processor (which may be the same or different processor(s) to those referred to in relation to block 102), determining additive manufacturing control instructions for the segments. The additive manufacturing control instructions comprise instructions for distributing the print agent composition, and the additive manufacturing control instructions for at least one segment are determined based on thermal properties of a print agent composition intended to provide the first color, and are determined to compensate for variations in object dimensions associated with the thermal properties. The thermal properties may be the amount of energy absorbed during object generation (i.e. when energy is applied to a layer in a layer-by-layer manufacturing operation) and/or an expected temperature during object generation associated with the print agent composition. The print agent composition may comprise at least one fusing agent and/or at least one colorant, and may be intended to cause or promote fusing in the underlying build material (and not to inhibit or reduce the likelihood of fusing therein). Not all of the segments may be associated with the print agent composition intended to provide the first color. For example, inner segments or ‘core’ segments which may not be visible may be associated with another composition, for example carbon black which may add strength and/or reduce costs.

In this way, the extent of distribution of fusing agent may be determined on a ‘segment by segment’ basis to compensate for anticipated deviations in object dimensions. In some examples, where an object is expected, by virtue of the thermal properties of the print agent composition to produce the first color, to grow, then the composition may be applied to fewer segments around a core. If however an object is expected, by virtue of the thermal properties of the print agent composition to produce the first color, to be smaller than anticipated, then the composition may be applied to more segments around a core.

The additive manufacturing control instructions in some examples may specify an amount of print agent to be applied to each of a plurality of locations on a layer of build material. For example, determining additive manufacturing control instructions may comprise determining ‘slices’ of a virtual build volume comprising virtual object(s) and rasterizing these slices into pixels. It may be noted that as these pixels may be associated with a depth related to the spacing between the slices, these pixels represent volumes, i.e. voxels, which may be the same voxels or different to those used to define the segments as described above). An amount of print agent (or no print agent) may be associated with each of the pixels. For example, if a pixel relates to a region of a build volume which is intended to solidify, the additive manufacturing control instructions may be derived to specify that fusing agent should be applied to a corresponding region of build material in object generation. If, however, a pixel relates to a region of the build volume which is intended to remain unsolidified, then additive manufacturing control instructions may be derived to specify that no agent, or a coalescence modifying agent such as a detailing agent, may be applied thereto, for example to cool the build material. If a pixel relates to a region of the build material which is intended to have a predetermined color, then at least one colorant (in some examples in combination with a fusing agent) may be applied thereto. In addition, the amounts of such agents may be specified in the derived instructions and these amounts may be determined based on, for example, thermal considerations and the like. In other examples, additive manufacturing control instructions may specify how to direct directed energy, or how to place a binding agent or the like.

In some examples, the method may further comprise generating an object based on the additive manufacturing control instructions (or ‘print instructions’). For example, such an object may be generated layer by layer. For example, this may comprise forming a layer of build material, applying print agents, for example through use of ‘inkjet’ liquid distribution technologies in locations specified in the additive manufacturing control instructions for an object model slice corresponding to that layer using at least one print agent applicator, and applying energy, for example heat, to the layer. Some techniques allow for accurate placement of print agent on a build material, for example by using print heads operated according to inkjet principles of two-dimensional printing to apply print agents, which in some examples may be controlled to apply print agents with a resolution of around 600 dots per inch (dpi), or 1200 dpi. A further layer of build material may then be formed and the process repeated, for example with the additive manufacturing control instructions for the next slice. In other examples, objects may be generated using directed energy, or through use of chemical binding or curing, or in some other way.

FIG. 2 shows a representation of a slice of an object 200 to be generated. A virtual volume 202, in this example comprising a cuboid, encloses the object 200. The virtual volume is divided into segments, which may be associated with different control instructions/print instructions as set out below.

In this example, the object 200 (the surface of which is marked with a bold line) comprises an elongate structure with a narrow central section 204 and two wider end sections 206a, 206b. In this example, a core segment 208 extends towards either end of the object via the central section 204. Two peripheral segments 210, 212 are formed concentrically around the core 208 and within the perimeter of the object 200. A further peripheral segment 214 is formed in a region of virtual build volume lying outside the extent of the object 200. The segments 208, 210, 212, 214 in this example are nested one inside another and at least one segment may be determined so as to follow the shape of the surface of the object. In particular, the peripheral segments 210, 212, 214 are defined relative to the surface, and have a predetermined thickness in this example, and the core may be a remaining segment once a predetermined number of inner and outer peripheral segments have been defined. Where a plurality of objects is considered, each may comprise segments nested around their respective cores.

In some examples determining additive manufacturing control instructions in block 104 may comprise determining whether to apply at least one of a fusing agent and a colorant (or a print agent composition) to a region of build material corresponding to a particular segment, or to leave the region of build material corresponding to that nested segment free of the fusing agent and/or colorant (or a print agent composition). In other examples, determining additive manufacturing control instructions in block 104 may comprise determining whether to associate one of a plurality of default amounts (for example, volume per unit area) of a predetermined print agent composition with a particular segment.

For example, a predetermined print agent composition which is associated with the first color may be determined, and may be associated with a particular behavior. For example, it may be known that objects of the first color may tend to be larger than intended. In such an example, the print agent composition to provide the first color may be associated with the inner segments 208, 210 and not with the segment 212 immediately inside the surface of the object 200. The object may ‘grow’ during manufacture to its intended size.

In other examples it may be known that objects of the first color may tend to be smaller than intended. In such an example, the print agent composition to provide the first color may be associated with at least one inner segment 208, 210, 212 and the outer peripheral segment 214, i.e. including a defined segment 214 which extends outside the periphery of the object model. The object once generated may be smaller than the area to which the print agent composition is applied, and therefore closer to its intended size.

In some examples herein, a tendency for an object to ‘grow’ may be associated with higher than nominal object generation temperatures, whereas the tendency for an object to be smaller than anticipated may be associated with lower than nominal object generation temperatures. The change in dimensions may be modelled based on previously generated objects, or may be evaluated based on theory, or may be estimated in some other way.

Where an object is intended to have more than one color, the segments associated with a print agent composition may vary depending on the color, and thus a segment may be selected for the application of print agent in a first region which is intended to have a first color, and not in a second region which is intended to have a second color. Thus, the print instructions may be determined segment by segment and color by color. As noted above, in some examples, inner segments such as a core may have a different color, as they may not be seen, and therefore will not affect the appearance of the object as having the first color. Thus the print agent composition for such segments may be selected to be cost effective and/or provide strength or the like.

Although in this example the core segment 208 is substantially central within the object 200, this need not be the case in all examples. In addition, while the peripheral segments 210, 212 in this example are concentric, and the boundaries thereof follow the contours of the surface of the object 200, they may lack either or both of these qualities in other examples. Indeed, in some examples, there may be a plurality of object core segments 208 around which peripheral segments 210, 212, 214 are formed.

In some examples, the thickness of the segments may be variable. Varying the thickness of the peripheral segments 210, 212, 214 may vary the accuracy with which the dimensions may be controlled. For example, thinner segments allow for precise variations, but may increase the processing resources used, as each segment may be processed separately.

Additional peripheral segments may be formed in other examples.

Where slices of the object are formed into segments, this may be carried out independently for different slices. For example, a core segment in one slice may be aligned with, partially aligned with, or non-overlapping to a core segment in a previous or subsequent slice. Different slices may have differing numbers of segments. In some examples, segments may be defined in three dimensions.

In some examples, at least one of a number of segments, a thickness of the segments, and a grouping of the segments for an object region is determined based on a local object geometry.

For example, the local geometry of the object at each point where the segment may exist may be considered. When considering a slice of the object, this may comprise a cross-section of the slice at that point. Where the object as a whole is to be segmented, the size of an object feature may be determined. In one example this may comprise integrating for ‘voxel density’.

Integrating for voxel density may comprise determining the number of voxels in, for example, a fixed spherical radius which contains part of an object model to determine local feature size (or circular radius in a slice). In such an example, if there is a high proportion of voxels within this local neighbourhood which are filled with the object, it may be determined that the feature is relatively large. If there are few voxels filled in the local neighbourhood, a small feature may be identified. In other examples, feature size may be determined in some other manner, for example having been tagged by a user or the like.

Thus, in some examples, the determination of additive manufacturing control instructions in block 104 may comprise a determination of whether to apply a print agent composition associated with the first color to each of a plurality of segments in a ‘virtual’ model of at least part of an intended fabrication chamber content in order to compensate for anticipated departures in object dimensions, and/or the concentration (or default concentration) with which a print agent is applied to a particular segment.

As generally larger deformations may be expected for larger objects or object regions, the segments may be defined to be thicker in such objects/regions. In practice, in some examples, this may be achieved by treating a plurality of thinner segments as a group, wherein the group size may increase with object size. For example, there may be a plurality of segments which are one voxel thick. Around a smaller object or object region, these may be treated in groups of one or two, but around a larger object or object region these may be treated in groups of three, four, five or more.

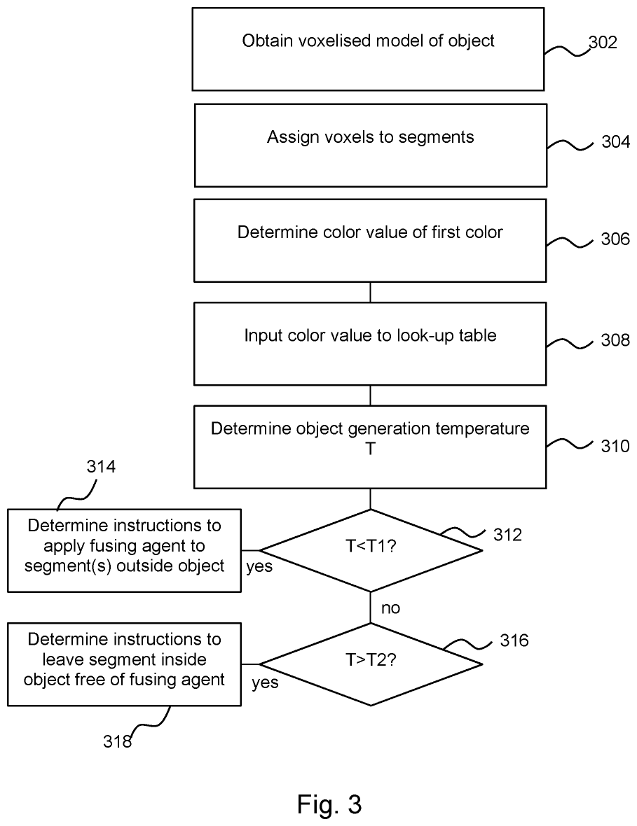

FIG. 3 is another example of a method for determining control instructions.

Block 302 comprises obtaining a voxelized 3D model of an object in a virtual volume. Block 304 comprises associating the voxels with predetermined segments. For example, this may comprise assigning the voxels based on their distance (for example in voxel count) from the surface of the object. In one example, each segment, at least initially, is defined to be one voxel thick (although these may be treated as groups in some examples)

Block 306 comprises determining a color value of the first color. This may for example comprise an RGB color value, an CIE L*a*b* color value, or any other means for identifying the color. Where the object is to be generated having more than one color, this may comprise determining a local color value for an object region, or determining each color value.

Block 308 comprises using the color value as an input to at least one look-up table associating color values with print agent compositions. For example, the look-up table may provide a ‘recipe’ of the relative amounts of one or more print agents in order to provide each of a plurality of colors. In some examples, such a look-up table may comprise a plurality of nodes (or values) associated with predetermined print agent compositions, each print agent composition being associated with a color value, and color values intermediate to those associated with defined nodes may be mapped to print agent compositions interpolated from the nodes. In some examples, the look-up table may specify default, or base, amounts for print agents.

A mapping resource such as a look-up table may allow selection of print agents, for example including at least one colorant. In one example, the selection may be made from a set of print agents comprising a Cyan, Magenta, Yellow and blacK (Key) (CMYK) color set (where the K may be provided by a ‘cosmetic’ black colorant, selected for its color providing qualities, and/or a carbon black fusing agent). The print agent set may comprise low-tint fusing agent and/or a carbon black fusing agent. In other examples, other sets of print agents may be provided. The print agent compositions stored in mapping resource may be intent to cause or promote fusing in the underlying build material (and not to inhibit or reduce fusing thereof).

Once the print agent composition has been determined, an object generation temperature T associated with that print agent composition is also determined in block 310. In some examples, this information may also be held in a look-up table (which may be the same or a different look-up table to that consulted in block 308) or may be determined using a predetermined relationship between the print agent(s) of the composition and temperatures, for example in association with the proportions specified in the ‘recipe’, or may be associated with temperatures in some other way.

In block 312, it is determined if a print agent composition intended to provide the first color is associated with an object generation temperature below a first threshold T1 (i.e. is a relatively low object generation temperature). If so, the method branches to block 314, which comprises determining additive manufacturing control instructions including instructions to apply fusing agent to a portion of build material corresponding to the voxels of a segment outside of a region corresponding a portion of the virtual volume occupied by the representation of at least a part of the object (e.g. segment 214 in FIG. 2). The fusing agent to be applied may be the print agent composition determined in block 308. In some examples, a base, or default, amount of at least one print agent for a segment (or at least the portion thereof associated with the first color) may be determined to provide the first color and this may be varied within the segment, for example based on local object geometry. The default amount may be a predetermined amount, for example being specified in the look-up table described in relation to block 308.

In block 316, it is determined if a print agent composition intended to provide the first color is associated with an object generation temperature above a second threshold T2 (i.e. is a relatively high object generation temperature). If so, the method branches to block 318, which comprises determining additive manufacturing control instructions including instructions to leave a portion of build material inside a boundary of a region corresponding to the voxels of segment of the virtual volume occupied by the representation of at least a part of the object free from fusing agent. For example, segment 212 in FIG. 2 may be left free from fusing agent (as well as segment 214). The fusing agent to be applied may be at least a component of the print agent composition determined in block 308. In some examples, a base, or default, amount of fusing agent/print agent composition for a segment may be determined and may be associated with the segment. However, this base, or default, amount may then be varied within the segment, for example based on local object geometry. In some examples, blocks 310, 312 and 316 may be implicit in a direct mapping from the color value to control instructions. If the determination in block 316 is negative, in some examples, control instructions may be determined such that the fusing agent may be applied up to—and not beyond—the boundary of a region corresponding to the voxels of segment of the virtual volume occupied by the representation of at least a part of the object. In other words, in such examples, where the expected temperature of object generation is between T1 and T2, the cross sectional area of the object may correspond to the area to which the fusing agent (or print material composition intended to promote fusing once energy is applied) is applied.

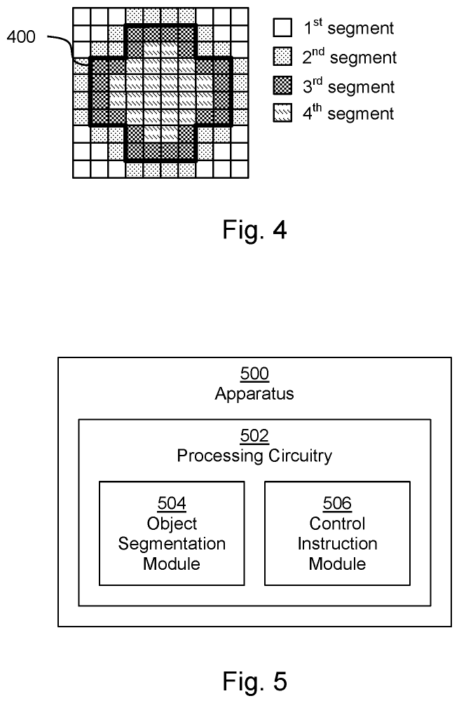

An example of a voxelized volume divided into segments is shown schematically in FIG. 4. An object 400 having a cross-like section is represented over a number of voxels, each having a square cross section. The voxels are associated with one of four segments: a first segment is relatively distant from the object surface and external thereto. A second segment follows (shares an edge with) the outer peripheral surface of the object 400. A third segment follows (shares an edge with) the inner peripheral surface of the object 400 and a fourth segment is relatively distant from the object surface and internal thereto. In some examples, the second and third segments may be defined, and the first and fourth segments may be undefined. In other examples, the segments may be defined to include voxels which share a corner with an object boundary. Although the object is shown divided in segments in two-dimensions in this example, in other examples, the segments could be formed in three-dimensions, forming Interlayer segments.

If a color is to be generated using relatively ‘cool’ print agent(s) (i.e. associated with a relatively low object generation temperature), the second, third and fourth segments may be associated with the print agents. If a color is to be generated using relatively ‘hot’ print agent(s) (i.e. associated with a relatively high object generation temperature), the fourth segment alone may be associated with the print agents. If a color is to be generated using print agent(s) associated with intermediate temperatures, the third and fourth segments may be associated with the print agent(s). As noted above, in some examples, inner segments such as core may be generated using a different print agent composition, as the color thereof may not be apparent and therefore other factors, such as cost or object strength, may be taken into account with sacrificing appearance aspects.

In some examples, the average volume of print agent (e.g. print agent composition amount) per voxel is consistent for the whole of an area corresponding to a segment. In another example, each segment may be associated with the same ‘base’ or default volume of print agent per voxel, which can then be further modified based on local geometry characteristics (including 2d-thickness, 3d-thickness, local curvature and the like), heat transfer modeling (which may model heat transfer between and/or within layers), and the like. The modifications could include modulating fusing agent (for example, carbon black fusing-agent, and/or low-tint fusing-agent), detailing-agent, and/or colorant amounts. For example, a ratio between carbon black and cosmetic black may change based on the thickness of a region, for example less ‘cosmetic’ black may be utilized in thinner regions to maintain strength.

In some examples, the amounts of fusing agent/print agent composition may alternatively or additionally be amended for each of the segments. For example, if a print agent composition intended to provide the first color (and intended to promote fusion when energy is supplied) is associated with an object generation temperature below a threshold (which may be the first threshold), determining the additive manufacturing control instructions may comprise determining instructions for applying fusing agent to build material corresponding to a segment comprising or bordering a boundary of a region occupied by the representation of at least a part of the object at a greater concentration to the concentration specified for a segment which is interior to the representation of the object. If however a print agent composition intended to provide the first color (and intended to promote fusion when energy is supplied) is associated with an object generation temperature above a fourth threshold (which may be the second threshold), determining the additive manufacturing control instructions may comprise determining instructions for applying fusing agent to build material corresponding to a segment comprising or bordering a boundary of a region occupied by the representation of at least a part of the object at a lower concentration to the concentration specified for a segment which is interior to the representation of the object. In other words, the concentration of a print agent composition to promote fusion when energy is supplied to be applied to segments which border the periphery (whether they are internal or external thereto) may be adjusted based on the expected fusing temperatures.

This may allow for more granular control of temperatures within the segments. For example, there may be a plurality of predetermined levels for print agent compositions, and a lower level may be selected for a segment near a boundary if the object may otherwise grow beyond the boundary. In another example, a higher level may be selected for a segment near a boundary if the object is expected to be smaller than anticipated. In another example, a segment outside the boundary may be associated with a relatively low level to control the thermal behavior around the boundary. In this way, more gradual thermal gradients may be established during object generation.

In some examples, the method of FIG. 1 and/or FIG. 3 may comprise generating at least one object using the additive manufacturing control instructions. For example, this may comprise forming a layer of build material, applying print agents, for example through use of ‘inkjet’ liquid distribution technologies in locations specified in the object model data for an object model slice corresponding to that layer using at least one print agent applicator, and applying energy, for example heat, to the layer. Some techniques allow for accurate placement of print agent on a build material, for example by using printheads operated according to inkjet principles of two-dimensional printing to apply print agents, which in some examples may be controlled to apply print agents with a resolution of around 600 dpi, or 1200 dpi. A further layer of build material may then be formed and the process repeated, for example with the object model data for the next slice.

FIG. 5 is an example of an apparatus 500 comprising processing circuitry 502. In this example the processing circuitry 502 comprises an object segmentation module 504 and a control instruction module 506. In use of the apparatus 500, the object segmentation module 504 represents a virtual volume comprising at least part of an object to be generated in additive manufacturing as a plurality of nested segments (which may be nested segments as described above). The control instruction module 506 determines control instructions for generating an object to have intended dimensions and an intended color. The control instructions may be determined to specify a print agent composition to provide the intended color and to specify a print agent distribution to at least one segment to compensate for variations in object dimensions associated with a thermal behavior of the print agent composition. The print agent composition may be a composition which is intended to promote fusion of build material when energy is supplied (rather than to inhibit or reduce fusion). The thermal behavior may be the amount of energy absorbed during object generation (i.e. when energy is applied to a layer in a layer-by-layer manufacturing operation) and/or an expected temperature during object generation associated with the print agent composition.

The shape of the segment(s) may follow the contours of the surfaces of an object or may differ therefrom. In some examples, the object segmentation module 504 may determine a virtual volume from at least one received object model and determining the virtual build volume may comprise modifying the received object model data, for example by segmenting the received object model. In some examples, the object model may be voxelized. In some examples, there may be a plurality of modelled objects, each having respective nested segments.

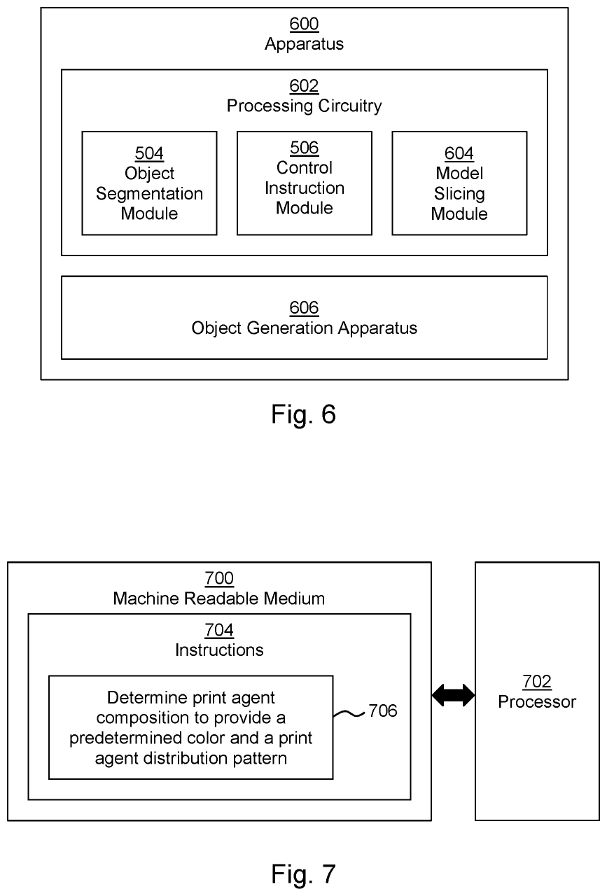

FIG. 6 shows an example of an apparatus 600 comprising processing circuitry 602 which comprises the object segmentation module 504 and the control instruction module 506, as well as a model slicing module 604 and an object generation apparatus 606.

In use of the apparatus 600, the model slicing module 604 may represent the object model as a plurality of slices corresponding to an integer number of object layers to be generated in layer by layer additive manufacturing. In some examples, one layer is represented by each slice. The slicing may occur before or after the object is segmented. In some examples, the slicing occurs after control instructions have been determined. However, when the slicing is carried out relatively early in the process, this allows the slices to be treated separately, which may allow for efficient use of data processing resources (for example, slices corresponding to layers to be formed later may be processed after slices corresponding to layers to be formed earlier, and in some examples while fabrication of earlier layers has begun).

The object generation apparatus 606, in use, generates the object according to the control instructions, and may to that end comprise additional components such as a print bed, build material applicator(s), print agent applicator(s), print agent source(s), heat source(s) and the like, not described in detail herein.

Generating an object using additive manufacturing may comprise providing build material. For example, one or more layers of build material may be formed of a granular material, such as a granular plastic material. The build material may be a powder, a liquid, a paste, or a gel. Examples of build material include semi-crystalline thermoplastic materials. A layer may for example be formed on a print bed, or on a previously formed and processed layer of build material.

Selected print agent and print agent combinations may be applied to selected regions of the build material which is to be fused in additive manufacturing. In some examples, application of print agent is carried out using a print agent distributor, for example a print head which may dispense print agent using ‘inkjet’ techniques or the like, and which may for example move relative to the layer of build material, and may perform at least one printing pass of the layer of build material. The print agent may be applied from a plurality of print agent sources to provide the first color (for example using appropriate halftoning techniques), or may be pre-mixed to provide the first color.

Where a print agent comprises a colorant, a selection of a plurality of colored agents, or at least one colored agent and a fusing agent may be applied.

Applying print agent may comprise applying a fusing agent. For example, the fusing agent may comprise an agent having a high energy absorptance (noting that a material's “absorptance” relates to its effectiveness in absorbing radiant energy) in the infra-red and/or near infrared range, for example a carbon black-based print agent, or an alternative (for example a low-tint) fusing agent, for example comprising a Caesium Tungsten Bronze, or a Caesium Tungsten Oxide composition which may be lighter in color than a carbon black based print agent.

In other examples, the colorant(s) themselves may be sufficiently efficient thermal absorbers to act as fusing agent. For example, the energy may be infrared energy: any agent which is not transparent in the infrared region will absorb at least some energy which may cause heating. In some examples, radiation to be applied may be increased so as to cause fusion with applied agents of relatively low absorptance. In some examples, print agent may be applied which comprises fusing agent for some target colors and not for others to achieve a print agent with an acceptable thermal absorptance.

In some examples, a fusion inhibiting agent may be applied to regions of the build material which are not intended to fuse. The fusion inhibiting agent may comprise a coolant, for example water or some other substance which tends to inhibit fusion. The use of fusion inhibiting agent may assist in providing well defined object boundaries, and limiting accidental fusion in portions of a layer of build material where fusion is not intended.

The build material may be heated by exposing the build material to radiation. For example, this may comprise exposing a layer containing the first region to a heat source such as a heat lamp. In some examples, heating is carried out at least partially concurrently with print agent application (for example, a print agent applicator may comprise a heat source). Heating may be carried out before, during and/or after print agent application.

In some examples, such processes may be carried out over each of a plurality of layers of build material until at least one object is formed.

The processing circuitry 502, 602 in FIG. 5 and FIG. 6 may carry out any or any combination of the blocks of FIG. 1 or 3, or implement the methods described in relation to any of FIGS. 1 to 4.

FIG. 7 shows a machine readable medium 700, which may be a non-transitory and/or tangible machine readable medium, and which is associated with a processor 702. The machine readable medium 700 stores instructions 704. The instructions 704 comprise instructions 706 which, when executed by the processor 702, cause the processor 702 to determine (i) a print agent composition to provide a predetermined color and (ii) a print agent distribution pattern for any print agent of the print agent composition to generate an object having the predetermined color. If the print agent composition is associated with an object generation temperature above a first threshold, the print agent distribution pattern for a layer is smaller than the intended extent of a corresponding object portion. The print agent composition may be a print agent composition which is intended to promote fusing of underlying build material when energy is suppled.

In some examples, the instructions 704 may comprise instructions to determine a print agent distribution pattern for a layer which is larger than the intended extent of a corresponding object portion if the print agent composition is associated with an object generation temperature below a second threshold.

In some examples, the instructions 704 may comprise instructions to determine the print agent distribution pattern for each of a plurality of predetermined nested regions of build material, wherein the number of nested regions to which the print agent composition is applied is determined based on the anticipated object generation temperatures of the print agent composition. The regions may be modelled as segments as has been described above. The size of the print agent distribution pattern may depend on, or be defined by, the number of nested regions to which the print agent composition is applied. In some examples, each region/segment (or at least the portion thereof associated with a particular color) may be associated with a default amount of a predetermined print agent or print agent composition based on an intended color. In some examples, that default amount may be varied within a segment, for example based on the local geometry of the object. In some examples, therefore, the default amount may be associated with a segment and then locally varied within the segment.

The instructions may comprise instructions to carry out any or any combination of the blocks of FIG. 1 or 3, or implement the methods described in relation to any of FIGS. 1 to 4.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that various blocks in the flow charts and block diagrams, as well as combinations thereof, can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (such as the object segmentation module 504, the control instruction module 506 and the model slicing module 604) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing device(s), so that the computer or other programmable data processing device(s) perform a series of operations to produce computer-implemented processing, thus the instructions executed on the computer or other programmable devices realize functions specified by block(s) in the flow charts in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
segmenting, using a processor, a virtual volume comprising a representation of at least a part of an object to be generated in additive manufacturing, wherein the virtual volume is segmented into a plurality of segments and wherein the object is intended to have a first color; and
determining, using a processor, additive manufacturing control instructions for the segments, wherein the additive manufacturing control instructions comprise instructions for distributing the print agent composition and the additive manufacturing control instructions for at least one segment are determined based on thermal properties of a print agent composition intended to provide the first color to compensate for variations in object dimensions associated with the thermal properties.

2. The method of claim 1, wherein determining additive manufacturing control instructions comprises determining whether to apply a print agent composition comprising at least one of a fusing agent and a colorant to a region of build material corresponding to a particular segment, or to leave the region of build material corresponding to that segment free of the print agent composition.

3. A method according to claim 1 wherein:
(i) if a print agent composition intended to provide the first color is associated with an object generation temperature below a first threshold, determining the additive manufacturing control instructions comprises determining instructions to apply the print agent composition to a portion of build material corresponding to a segment outside of a region corresponding to a portion of the virtual volume occupied by the representation of at least a part of the object; and
(ii) if a print agent composition intended to provide the first color is associated with an object generation temperature above a second threshold, determining the additive manufacturing control instructions comprises determining instructions to leave a portion of build material inside a boundary of a region corresponding to a segment of the virtual volume occupied by the representation of at least a part of the object free from the print agent composition.

4. A method according to claim 1 wherein:
(i) if a print agent composition intended to provide the first color is associated with an object generation temperature below a third threshold, generating the additive manufacturing control instructions comprises determining instructions for applying the print agent composition to build material corresponding to a segment comprising or bordering a boundary of a region occupied by the representation of at least a part of the object at a greater concentration to a concentration specified for a segment which is interior to the representation of the object; and
(ii) if a print agent composition intended to provide the first color is associated with an object generation temperature above a fourth threshold, determining the additive manufacturing control instructions comprises determining instructions for applying the print agent composition to build material corresponding to a segment comprising or bordering a boundary of a region occupied by the representation of at least a part of the object at a lower concentration to a concentration specified for a segment which is interior to the representation of the object.

5. A method according to claim 1 wherein determining the control instructions comprises determining a color value for the first color and using the color value as an input to at least one look-up table associating color values with print agent compositions for each of a plurality of segments.

6. A method according to claim 5 wherein at least one look-up table comprises a plurality of nodes associated with predetermined print agent compositions, and wherein color values intermediate to the nodes are mapped to print agent compositions interpolated from the nodes.

7. A method according to claim 1 wherein the virtual volume is voxelized and segmenting the virtual volume comprises associating at least one voxel with a segment.

8. A method according to claim 1 wherein at least one segment is outside an extent of the representation of the object.

9. A method according to claim 1 wherein segmenting the virtual volume comprises segmenting the virtual volume into a core segment, an inner peripheral segment within an object boundary and an outer peripheral segment outside the object boundary.

10. An apparatus comprising processing circuitry, the processing circuitry comprising:
a segmentation module to represent a virtual volume comprising at least part of an object to be generated in additive manufacturing as a plurality of nested segments; and
a control instruction module to determine control instructions for generating an object to have intended dimensions and an intended color, wherein the control instructions are determined to specify a print agent composition to provide the intended color and to specify a print agent distribution to at least one segment to compensate for variations in object dimensions associated with a thermal behavior of the print agent composition.

11. The apparatus according to claim 10 further comprising a model slicing module to represent at least a portion of the virtual volume as a plurality of slices corresponding to an integer number of object layers to be generated in layer by layer additive manufacturing.

12. The apparatus according to claim 10 further comprising an object generation apparatus to generate the object according to the control instructions.

13. A tangible machine readable medium storing instructions which, when executed by a processor, cause the processor to:
determine a print agent composition to provide a predetermined color and a print agent distribution pattern for any print agent of the print agent composition to generate an object having the predetermined color wherein:
if the print agent composition is associated with an object generation temperature above a first threshold, the print agent distribution pattern for a layer is smaller than an intended extent of a corresponding object portion.

14. A tangible machine readable medium according to claim 13 storing further instructions which, when executed by a processor, cause the processor to:
if the print agent composition is associated with an object generation temperature below a second threshold, determine a print agent distribution pattern for a layer which is larger than the intended extent of a corresponding object portion.

15. A tangible machine readable medium according to claim 13 storing further instructions which, when executed by a processor, cause the processor to:
determine the print agent distribution pattern for each of a plurality of predetermined nested regions of build material, wherein a number of nested regions to which the print agent composition is applied is determined based on an anticipated object generation temperature of the print agent composition.
